(19) United States
(12) Patent Application Publication
(10) Pub. No.: US 2016/0134464 A1
(43) Pub. Date: May 12, 2016

(54) CORE NETWORK NODE, RADIO ACCESS NETWORK NODE AND METHODS THEREIN FOR CONTROLLING OVERLOAD IN CORE NETWORK

(71) Applicant: TELEFONAKTIEBOLAGET L M ERICSSON (PUBL), Stockholm (SE)

(72) Inventors: Angelo Centonza, Stockholm (SE); György Miklós, Pilisborosjenö (HU); Paul Schliwa-Bertling, Ljungsbro (SE)

(21) Appl. No.: 14/898,690

(22) PCT Filed: Feb. 25, 2014
(86) PCT No.: PCT/SE2014/050229

§ 371 Date: Dec. 15, 2015

Related U.S. Application Data
(60) Provisional application No. 61/843,954, filed on Jul. 9, 2013.

(51) Int. Cl. H04L 12/24; H04W 28/02

(52) U.S. Cl. CPC H04L 41/0604; H04W 28/0284

(57) ABSTRACT

A method in a Core Network, CN, node for managing signalling from a Radio Access Network, RAN, to a CN in a wireless communication network. The CN node transmits to a RAN node an indication of overload in the CN. The overload is due to signalling from the RAN. The indication of overload comprises an indication to reduce a rate of reporting congestion information to the CN.

### TECHNICAL FIELD

Embodiments herein relate to a core network node, a radio access network node and methods therein. In particular, embodiments herein relate to managing signalling from a radio access network to a core network in a wireless communication network.

### BACKGROUND

In a typical radio communications network also referred to as e.g. telecommunications systems or wireless communications network, wireless terminals, also known as mobile stations and/or user equipments (UEs), communicate via a Radio Access Network (RAN) to one or more Core Networks (CN). The RAN covers a geographical area which is divided into cell areas, with each cell area being served by a base station, e.g., a radio base station (RBS), which in some networks may also be called, for example, a “BTS”, “NodeB” or “eNodeB”. A cell is a geographical area where radio coverage is provided by the radio base station at a base station site or an antenna site in case the antenna and the radio base station are not collocated. Each cell is identified by an identity within the local radio area, which is broadcast in the cell. Another identity identifying the cell uniquely in the whole mobile network is also broadcasted in the cell. One base station may have one or more cells. A cell may be downlink and/or uplink cell. The base stations communicate over the air interface operating on radio frequencies with the user equipments within range of the base stations.

A Universal Mobile Telecommunications System (UMTS) is a third generation wireless communication network, which evolved from the second generation (2G) Global System for Mobile Communications (GSM). The UMTS Terrestrial RAN (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks and UTRAN specifically, and investigate enhanced data rate and radio capacity. In some versions of the RAN as e.g. in UMTS, several radio base stations may be connected, e.g., by landlines or microwave, to a controller node, such as a radio network controller (RNC), which supervises and coordinates various activities of the plural radio base stations connected thereto. The RNCs are typically connected to one or more core networks.

Specifications for the Evolved Packet System (EPS) have been completed within the 3GPP and are further evolved in the coming 3GPP releases. The EPS comprises the Evolved Universal Terrestrial RAN (E-UTRAN), also known as the Long Term Evolution (LTE) radio access, and the Evolved Packet Core (EPC), also known as System Architecture Evolution (SAE) core network. E-UTRAN/LTE is a variant of a 3GPP radio access technology wherein the radio base station are directly connected to the EPC network, i.e. a radio network controller concept as realized in UMTS with an RNC does not exist. In general, in EPS the functions of an RNC are distributed between the radio base stations, i.e. eNodeBs and the core network. As such, the RAN of an EPS has an essentially “flat” architecture comprising radio base station without being controlled by RNCs.

The 3GPP is currently working on standardization of Release 12 of the LTE concept. The architecture of the LTE system is shown in FIG. 1, including an E-UTRAN comprising radio access network nodes, such as evolved Node Bs (eNBs or eNode Bs), and evolved packet core nodes, e.g. Mobility Management Entity (MME) or Serving Gateway (S-GW). Interfaces between the nodes enable communication between the nodes. For example the eNBs may communicate with other eNBs over X2 interfaces, while the eNBs may communicate with the evolved packet core nodes over S1 interfaces.

Recently, in the context of the 3GPP User Plane Congestion management (UPCON) work item, a number of solutions for managing user plane congestion have been put forward, which utilize congestion feedback from the RAN to the CN. This has been documented in 3GPP TR 23.705 version 0.5.0 section 6. When the RAN indicates congestion to the CN, the CN may take actions to mitigate the congestion, such as limiting some classes of traffic.

Congestion feedback as proposed so far may be based on the measurement of the load in the RAN, i.e. resource utilization, and providing congestion feedback when an average load over a period of time exceeds a pre-defined threshold level or it may be based on Quality of Service (QoS) degradation, i.e. providing congestion feedback when a service has not fulfilled certain QoS criteria, e.g. throughput, for a given time window. Load-based congestion feedback is illustrated in FIG. 2. In FIG. 2 a RAN node communicating with two UEs, UE1 and UE2, sends congestion information, i.e. congestion feedback, to a CN node. The CN node calculates the congestion based on the total user plane traffic. The arrows from the CN node to the RAN node indicate data traffic. The rectangles on these arrows indicate IP packets. QoS based congestion feedback follows a very similar mechanism to that shown in FIG. 2. Possible examples for load-based congestion feedback may be:
whether air interface radio resource utilization exceeds 90% over a 10 sec averaging period;
whether the total sum of buffer lengths for all users averaged over 10 sec exceeds a pre-defined threshold.

Possible examples of QoS based feedback may be:
whether a bearer service flow is below a target throughput for a pre-set time duration
Whether the packet delivery delay and/or packet drop rate are above a pre-set threshold

The feedback provided by the RAN node about congestion may be signalled in a number of ways. One possible way is to signal such feedback on the basis of a cell level congestion, i.e. on the basis of statistics collected for the whole cell over a given time period and showing that e.g. load in the cell is higher than a certain threshold or QoS in the cell is below pre-set thresholds.

Another possible way is to signal congestion level on a per bearer level, i.e. the monitoring in this case may be done purely on a single bearer traffic flow and if the resources available to serve the bearer traffic are not sufficient or if the QoS of the bearer service is not fulfilled a message containing congestion feedback for the bearer may be sent back to the CN.

A congestion indication per bearer level may result in more signalling from the RAN to the CN. This is because signalling has to be generated for each congested bearer in the network and when congestion occurs the likelihood of many bearers being affected is very high. Note that it may be possible to define signalling optimization techniques, where congestion information for several bearers are sent together in a single message, e.g. from the eNB to the MME. However, even with such signalling optimizations the total signalling from the RAN to the CN may be high. High signalling levels from the RAN to the CN may lead to control plane congestion in the CN due to the signalling from the RAN, which is a problem in that the performance of the wireless communication network is reduced.

### SUMMARY

An object of embodiments herein is to provide mechanisms to improve the performance of a wireless communication network.

According to a first aspect of embodiments herein, the object is achieved by a method in a Core Network, CN, node for managing signalling from a Radio Access Network, RAN, to a CN in a wireless communication network. The CN node transmits to a RAN node an indication of overload in the CN. The overload is due to signalling from the RAN. The indication of overload comprises an indication to reduce a rate of reporting congestion information to the CN.

According to a second aspect of embodiments herein, the object is achieved by a CN node for managing signalling from a RAN to a CN in a wireless communication network. The CN node comprises a transmitting circuit configured to transmit to a RAN node an indication of overload in the CN. The overload is due to signalling from the RAN. The indication of overload comprises an indication to reduce a rate of reporting congestion information to the CN.

According to a third aspect of embodiments herein, the object is achieved by a method in a RAN node for managing signalling from a RAN to a CN in a wireless communications network. The RAN node receives from a CN node an indication of overload in the CN. The overload is due to signalling from the RAN. The indication of overload comprises an indication to reduce a rate of reporting congestion information from the RAN to the CN. The RAN node reduces the rate of reporting congestion information to the CN, based on the received indication of overload.

According to a fourth aspect of embodiments herein, the object is achieved by a RAN node for managing signalling from a RAN to a CN in a wireless communications network. The RAN node comprises a receiving circuit configured to receive from a CN node an indication of overload in the CN. The overload is due to signalling from the RAN. The indication of overload comprises an indication to reduce a rate of reporting congestion information from the RAN to the CN. The RAN node further comprises a reduction circuit configured to reduce the rate of reporting congestion information to the CN, based on the received indication of overload.

Hence, in embodiments herein the CN node transmits to the RAN node the indication of overload in the CN, which overload is due to signalling from the RAN. The indication of overload comprises the indication to reduce the rate of reporting congestion information to the CN. The RAN node receives from the CN node the indication of overload in the CN. Since the RAN node reduces the rate of reporting congestion information to the CN, based on the received indication of overload, the signalling level in the CN is reduced and the performance of the wireless communication network is improved. Thus, an advantage of embodiments herein is that embodiments enable full control of the level of signalling at which the congestion information is reported from the RAN, hence preventing outages or performance degradation that may result in a reduction of user equipments and traffic served.

### BRIEF DESCRIPTION OF THE DRAWINGS

Embodiments will now be described in more detail in relation to the enclosed drawings, in which:

FIG. 1: is a schematic block diagram illustrating an LTE architecture and showing logical interfaces between eNBs (X2) and between eNB and MME/S-GW (S1);

FIG. 2: is a schematic block diagram illustrating load-based congestion feedback;

FIG. 3: is a signalling diagram illustrating an example of congestion indication signalling from the RAN to the CN in LTE;

FIG. 4: is a combined schematic block diagram and signalling diagram illustrating the Overload procedure in UTRAN;

FIG. 5: is a combined schematic block diagram and signalling diagram illustrating the Overload Start procedure in LTE;

FIG. 6: is a schematic block diagram illustrating embodiments of a wireless communication network;

FIG. 7a: is a combined flow chart and signalling scheme according to embodiments herein;

FIG. 7b: is a combined flow chart and signalling scheme according to some other embodiments herein;

FIG. 8: is a flowchart depicting embodiments of a method in a CN node;

FIG. 9: is a schematic block diagram illustrating a CN node according to embodiments herein; and

FIG. 10: is a flowchart depicting embodiments of a method in a RAN node according to embodiments herein.

FIG. 11: is a schematic block diagram illustrating a RAN node according to embodiments herein.

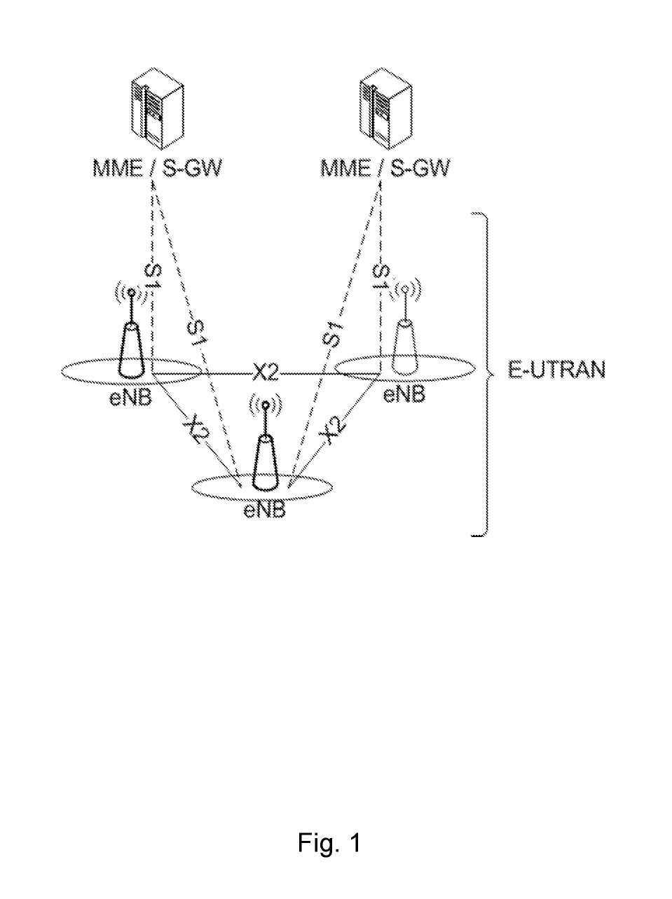

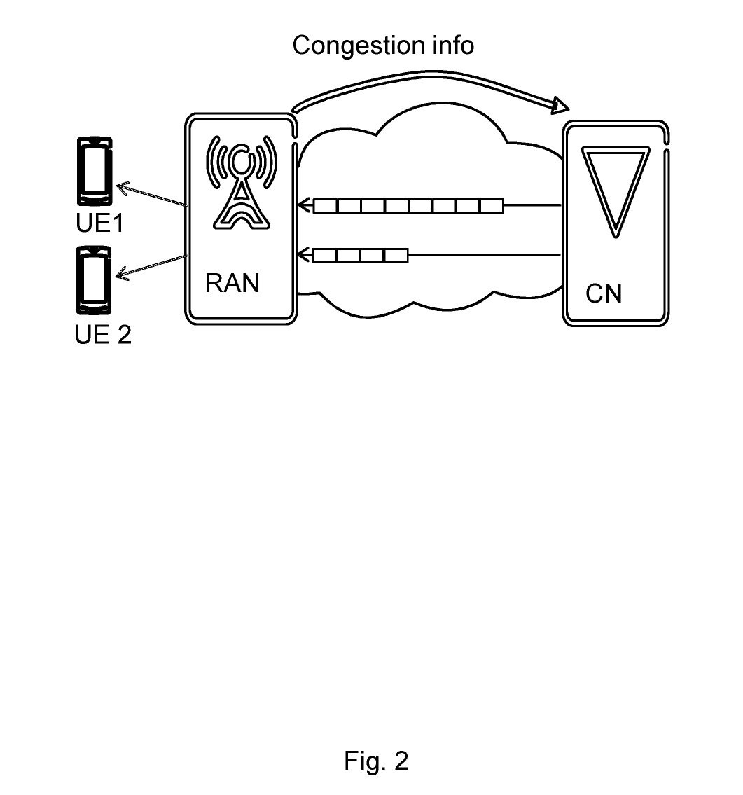

### DETAILED DESCRIPTION

As part of developing embodiments herein, a problem will first be identified and discussed.

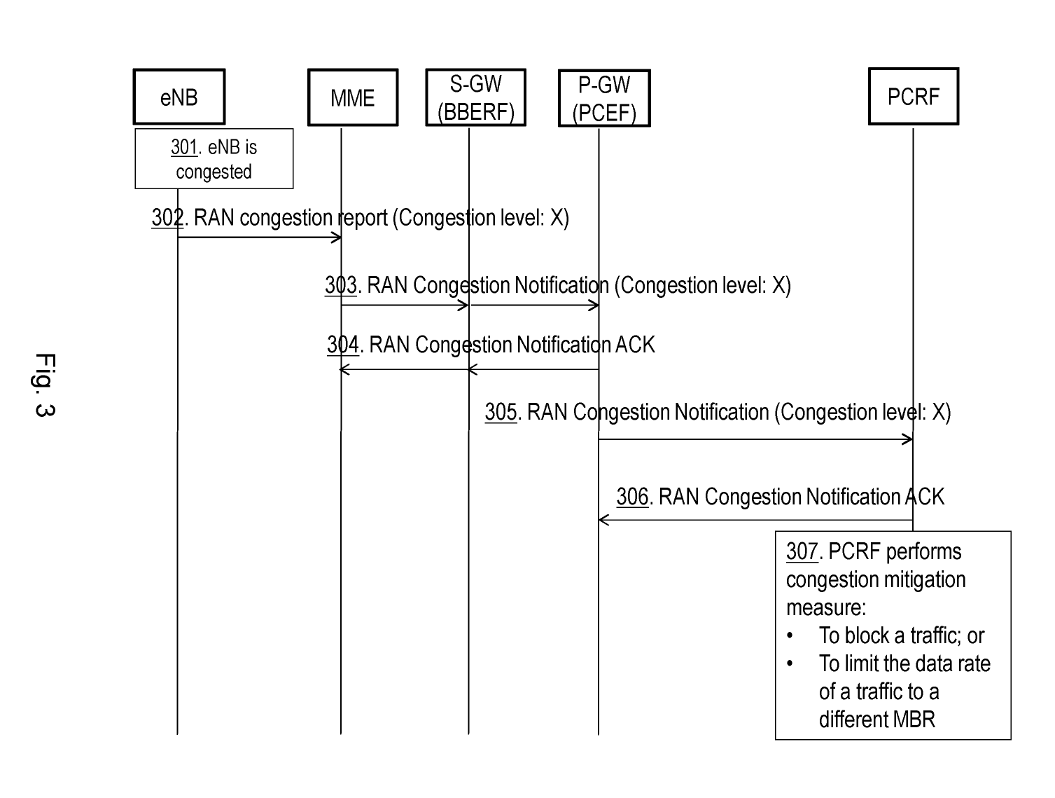

As shown in the 3GPP Technical Report (TR) 23.705 version 0.5.0, a possible way to signal congestion indications from the RAN to the CN in LTE is as shown in FIG. 3. FIG. 3 will now be described with the following actions.

Action 301.

An eNB notes that it is congested.

Action 302.

The eNB sends information about the congestion in a RAN congestion report to an MME. The congestion report indicates a certain congestion level, e.g. congestion level X.

Action 303.

The MME 313 forwards the information about the congestion in a RAN Congestion Notification to an S-GW comprising a Bearer Binding and Event Reporting Function (BBERF) entity. The RAN Congestion Notification indicates the congestion level. The S-GW forwards the RAN Congestion Notification to a Packet Data Network Gateway (P-GW) comprising a Policy and Charging Enforcement Function (PCEF) entity.

Action 304.

The P-GW sends a RAN Congestion Notification Acknowledgement (ACK) to the S-GW.

Action 305.

The P-GW forwards the Congestion Notification comprising the congestion level to a Policy and Charging Rules Function (PCRF) entity.

Action 306.

The PCRF entity sends a RAN Congestion Notification Acknowledgement (ACK) to the P-GW.

Action 307.

The PCRF entity performs congestion mitigation measures, such as to block a traffic, or to limit the data rate of a traffic to a different Maximum Bit Rate (MBR).

As mentioned above the signalling of congestion indication from the RAN to the CN may be high. This may especially be the case if the RAN uses a short time-averaging period for determining the congestion. Then the result may fluctuate, causing very frequent new signalling to be sent to the CN in order to update the congestion information to the CN. Also, the signalling generated by congestion indications may be higher if dedicated procedures are used. Namely, if the congestion indication is sent from the RAN to the CN by means of dedicated messages that would not otherwise be sent, then the amount of signalling generated in the CN nodes increases.

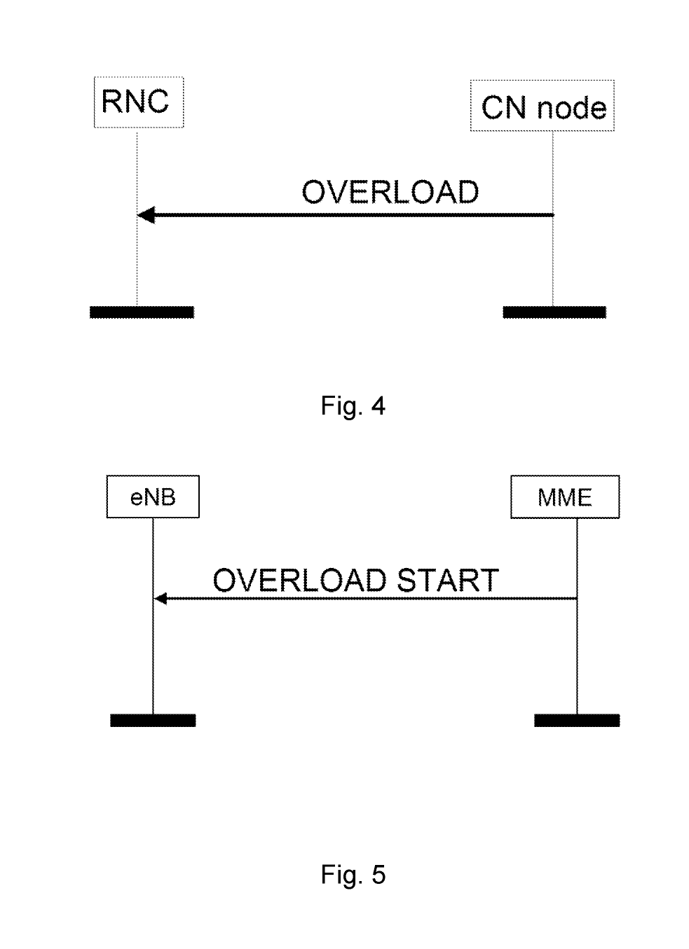

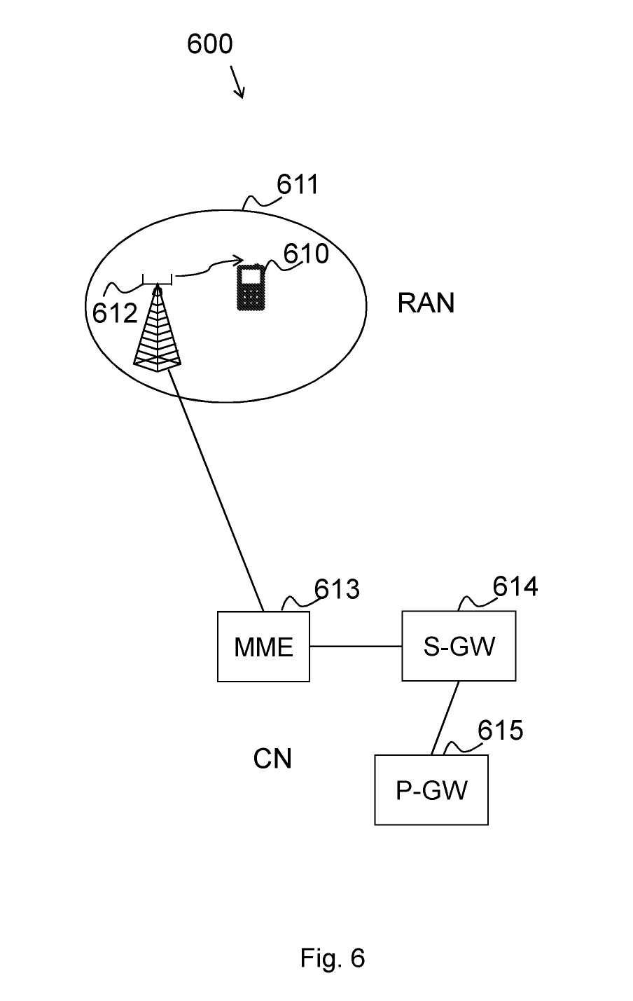

In current wireless communication networks such as UTRAN and E-UTRAN procedures for signalling a situation of overload from the CN to the RAN exist. In particular, the procedures currently standardised are the OVERLOAD procedure in TRAN, shown in FIG. 4 and the OVERLOAD START procedure in LTE shown in FIG. 5. FIG. 4 is a signalling diagram showing a CN node which sends an OVERLOAD message to an RNC, while FIG. 5 is a signalling diagram showing an MME which sends an OVERLOAD START message to an eNB. The OVERLOAD START procedure has a corresponding OVERLOAD STOP procedure. These procedures allow the CN to indicate to the RAN that a signalling overload is occurring. However, the currently standardised mechanisms are not suitable for reduction of signalling of congestion indications. The latter is especially true for the CASE of E-UTRAN, where the signalling reduction actions taken by the RAN upon reception of the OVERLOAD START message imply rejection of access to the RAN and the network for UEs. This is not a desirable action in case the overload is caused by the congestion indication signalling. Rejecting access to the network for UEs implies denying access to user equipments and does not reduce the existing signalling load due to the congestion indication signalling, also referred to as congestion signalling and signalling of congestion information herein.

For the case of UTRAN, the OVERLOAD procedure is used to reduce signalling by generic steps. However, this procedure provides an incremental reduction and does not allow to, e.g. fold back to a pre-set signalling frequency, which might help immediately reducing congestion indication signalling. Furthermore, current wireless communication networks are missing mechanisms to control the signalling of the congestion information from the RAN to the CN in e.g. situations of signalling overload in the RAN. Current signalling overload control procedures are either too vague and not reactive enough to control congestion indication signalling, or the signalling overload control procedures are simply actions that do not tackle reduction of signalling frequency for congestion indication.

In embodiments herein the existing procedures for controlling the signalling from the RAN are enhanced with specific actions targeting reduction of congestion indication signalling and new procedures are introduced to reduce such signalling.

Embodiments herein relate to wireless communication networks.

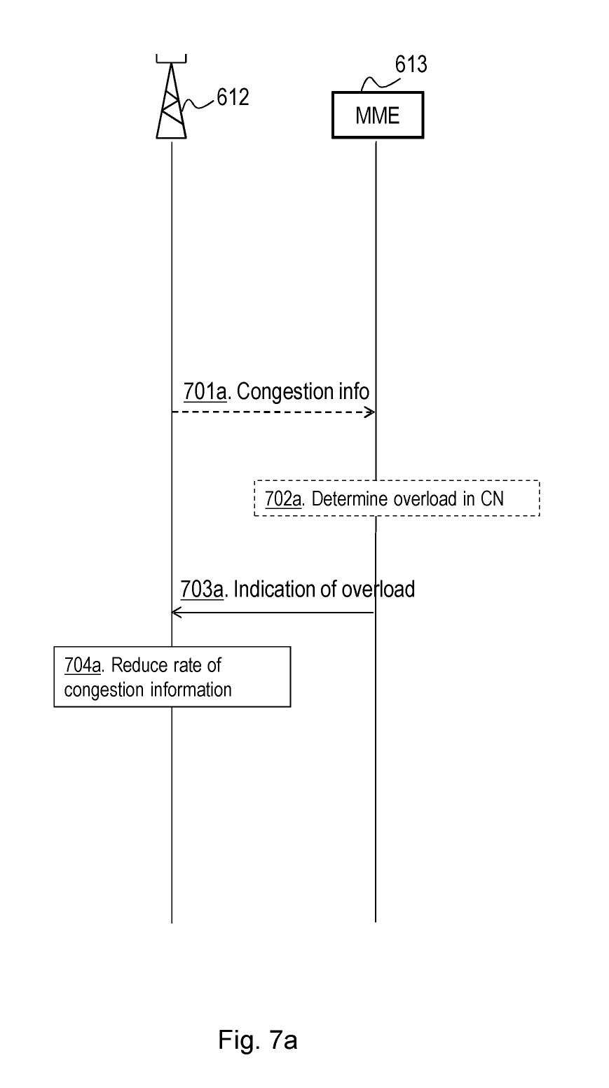

FIG. 6 is a schematic overview depicting a wireless communication network 600. The wireless communication network 600 comprises one or more RANs and one or more CNs. The wireless communication network 600 may use a number of different technologies, such as LTE, LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. The wireless communication network 600 is exemplified herein as an LTE network.

In the wireless communication network 600, a wireless device 610, also known as a mobile station, a user equipment and/or a wireless terminal, communicates via a RAN to one or more CNs. It should be understood by a person skilled in the art that “wireless device” is a non-limiting term which means any wireless terminal, user equipment, Machine Type Communication (MTC) device, a Device to Device (D2D) terminal, or node e.g. Personal Digital Assistant (PDA), laptop, mobile, sensor, relay, mobile tablets or even a small base station communicating within respective cell.

The wireless communication network 600 covers a geographical area which is divided into cell areas, e.g. a cell 611 being served by a radio base station being a RAN node 612. The radio base station may also be referred to as a NodeB, an evolved Node B (eNB, eNode B), a base transceiver station (BTS), Access Point Base Station, base station router, or any other network unit capable of communicating with a user equipment within the cell served by the radio base station depending e.g. on the radio access technology and terminology used. The radio base station may serve one or more cells, such as the cell 611. The radio base station is an example of the RAN node 612, other examples of a RAN node may be an RNC or a Base Station Controller (BSC).

A cell is a geographical area where radio coverage is provided by radio base station equipment at a base station site or at remote locations in Remote Radio Units (RRU). The cell definition may also incorporate frequency bands and radio access technology used for transmissions, which means that two different cells may cover the same geographical area but using different frequency bands. Each cell is identified by an identity within the local radio area, which is broadcast in the cell. Another identity identifying the cell 611 uniquely in the whole wireless communication network 6 is also broadcasted in the cell 611. The radio base station communicates over the air or radio interface operating on radio frequencies with the wireless device 610 within range of the radio base station. The wireless device 610 transmits data over the radio interface to the radio base station in Uplink (UL) transmissions and the radio base station transmits data over an air or radio interface to the wireless device 610 in Downlink (DL) transmissions.

Furthermore, the wireless communications network 6 comprises a CN node 613, 614, 615 such as a Mobility Management Entity (MME) 613, a Serving GPRS Support Node (SGSN), an S-GW 614, a Bearer Binding and Event Reporting Function (BBERF) entity, PCRF entity, a Packet Data Network Gateway (P-GW) 615, a Gateway GPRS Support Node (GGSN) or similar. Some of the above mentioned examples of CN nodes, e.g. the MME 613, may be connected directly to the RAN. The MME 613 is for example connected to the RAN with an 51 interface. CN nodes that are directly connected to the RAN may communicate directly with the RAN nodes. Other CN nodes which are not directly connected with the RAN, may also communicate with RAN nodes via other CN nodes, such as the MME 613.

In discussion of the topic of User Plane Congestion Management (UPCON), a number of so called closed loop solutions have been discussed, where RAN nodes, such as the RAN node 612 signal information concerning a situation of congestion, of different levels, e.g. low, medium, high and of different types, e.g. load information, QoS information, to CN nodes, such as the CN node 613, 614, 615.

In a situation of congestion at radio level it is likely that such signalling of congestion information occurs very frequently. An excessive signalling load caused by signalling of congestion information could cause overloads in the CN node 613, 614, 615 that receive the signalling and that need to process the information.

Embodiments herein provide mechanisms specified to control the frequency of signalling of congestion information or to at least reduce the signalling load caused by such signalling in the CN node 613, 614, 615.

For example, embodiments herein provide mechanisms to indicate a situation of signalling overload at the CN node 613, 614, 615. The signalling overload may have occurred at least partly due to congestion indications from the RAN or the RAN node 612. The mechanisms rely on signalling an indication from the CN node 613, 614, 615 to the RAN node 612 that an overload has occurred due to signalling from the RAN. The signalling of the indication may either reuse existing procedures for signalling overload, such as the OVERLOAD procedure in UTRAN and the OVERLOAD START procedure in LTE, or use procedures that are based on dedicated new procedures.

Embodiments herein allow the RAN node 612 to either gradually reduce the signalling traffic due to ‘congestion indication signalling’ depending on the signalling load in the CN node 613, 614, 615 or to automatically default to pre-set signalling values that ensure a bearable signalling load for the CN node 613, 614, 615 involved.

The overload indication may be sent directly to the RAN node 612, for example from a CN node that is directly connected to the RAN, such as the MME 613 or an SGSN. The overload indication may also be sent via other CN nodes such as the MME 613, the SGSN, the S-GW 614 or the P-GW 615. The overload indication is forwarded to the RAN node 612. In other words, the overload indication may be sent directly to the RAN node 612 from a CN node that is directly connected to the RAN, such as the MME 613 or an SGSN. The overload indication may also be sent from a CN node that is not directly connected to the RAN, such as the P-GW 615, and sent via another node, such as the MME 613 or SGSN, which forwards the indication.

Note that besides LTE, embodiments herein may similarly be applied to UTRAN or GERAN radio access technologies as well.

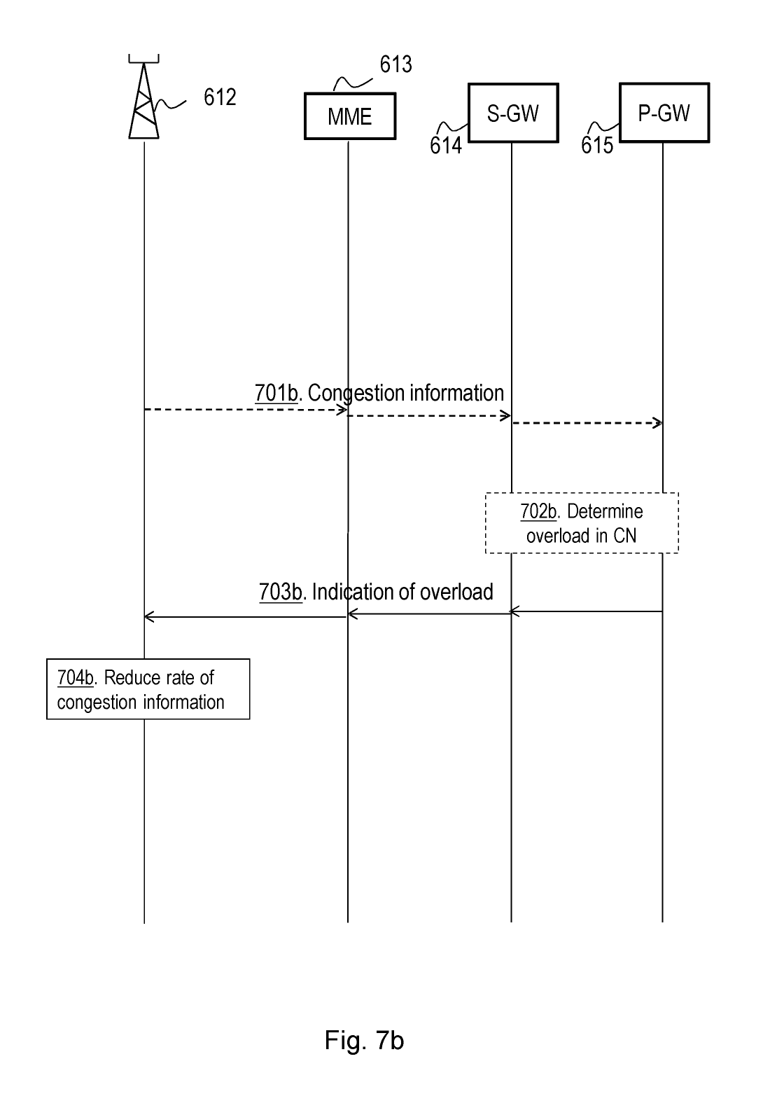

Example embodiments of a method for managing signalling from the RAN to the CN in the wireless communication network 600 will now be described with reference to a combined flowchart and signalling diagram depicted in FIG. 7a. FIG. 7a describes a basic scenario where the CN node 613, 614, 615 is the MME 613 or a similar CN node, e.g. an SGSN. Thus the method takes place in the MME 613 or similar CN node and in the RAN node 612.

The method comprises the following actions, which actions may be taken in any suitable order. Dashed lines of some boxes in FIG. 7a indicate that this action is not mandatory.

Action 701a.

The RAN node 612 may transmit, to the MME 613, an indication of congestion at the RAN node 612, also referred to as Congestion info in FIG. 7a. As stated above, possible examples of such an indication for load-based congestion feedback may be: whether the air interface radio resource utilization exceeds 90% over an averaging period of 10 s; whether the total sum of buffer lengths for all users averaged over 10 s exceeds a pre-defined threshold; or similar. Possible examples of such an indication for QoS based feedback may be: whether a bearer service flow is below a target throughput for a pre-set time duration; whether the packet delivery delay and/or packet drop rate are above a pre- set threshold or similar. The congestion info or feedback may be signalled in different ways also mentioned above.

Action 702a.

The MME 613 may determine overload in the CN, e.g. that the MME 613 or another CN node 614, 615 is overloaded due to signalling from the RAN.

The overload in the CN may be due to congestion information from the RAN. For example, the congestion information may be any of the information mentioned in action 701 above.

In other words the MME 613 may determine that an overload of signalling has occurred. The overload may have occurred due to the indication from the RAN node 612 25 received in action 701. The overload may also have occurred due to another indication from another RAN node.

This action is related to action 801 below.

Action 703a.

If the signalling overload is caused either in full or in part by the signalling of indications of congestion, preventing wireless devices from connecting to the network would not be the most appropriate action. Therefore it is more efficient to specify dedicated values to indicate, explicitly or implicitly, a reduction in the congestion indication signalling and still allow new and existing wireless devices to connect to the network.

Therefore the MME node 613 transmits to the RAN node 612 an indication of overload in the CN. The indication of overload comprises an indication to reduce a rate of reporting congestion information to the CN.

For example, the MME 613 may transmit to the RAN node 612 an indication of overload at the MME 613. The indication may comprises an indication that the overload is due to congestion signalling from a RAN node, e.g. from the RAN node 612 or another RAN node.

In some embodiments the indication to reduce the rate of reporting congestion information to the CN comprises an indication to set the rate of reporting congestion information to the CN to a specific value. The specific value may be a pre-set or pre-configured value. Such pre-configured value may for example be configured via an Operation Administration and Maintenance (OAM) system. The indication to reduce the rate of reporting congestion information may also indicate to completely stop indicating congestion level changes to the CN, just report a constant, possibly pre-configured, level of congestion.

In some embodiments the indication to reduce the rate of reporting congestion information to the CN comprises an indication to not send a part of the generated congestion information, for example, to skip sending a given percentage of the generated messages.

The indication to reduce the rate of reporting congestion information to the CN may comprise an indication to increase a time-averaging period used for determining congestion information that is to be sent to the CN. In practice this may be done by increasing a time-averaging constant used for determining congestion information, and use longer time-averaging as a means to reduce the congestion indication signalling. This is an implicit means to reduce the signalling load by the percentage. The effect of increasing the time-averaging period is a more stable result of the determination of the congestion level in the RAN node 612. Thus fewer changes are noticed and less information is generated.

The transmitting of the indication of overload may be triggered by an overload at a second CN node, e.g. at the S-GW 614 or at the P-GW 615.

Embodiments herein comprising the interaction of more than one CN node will be described in more detail below.

The indication of overload may be transmitted in an OVERLOAD message or in an OVERLOAD START message.

This action is related to action 802 below.

Action 704a.

When the RAN node 612 has received the indication of overload in the CN from the MME 613 in action 703a, the RAN node 612 reduces the rate of reporting congestion information to the CN, based on the received indication of overload.

In other words the RAN node 612 performs an action to reduce the signalling load in the CN due to congestion signalling; i.e. the RAN node 612 reduces the amount or similarly the rate of congestion indications. For example, this may be done by gradually decreasing the rate of congestion signalling or reducing the rate of congestion signalling to a pre-set value of rate of congestion signalling.

In some embodiments the RAN node 612 reduces the rate of reporting congestion information to the CN by setting the rate of reporting congestion information to the CN to the specific value. The specific value may be determined by the indication of overload or by the pre-set value.

The RAN node 612 may reduce the rate of reporting congestion information to the CN by increasing the time-averaging period used for determining congestion information that is to be sent to the CN.

In some embodiments the RAN node 612 reduces the rate of reporting congestion information to the CN by not reporting a part of the generated congestion information.

Since the RAN node 612 reduces the rate of reporting congestion information to the CN, based on the received indication of overload, the signalling level in the CN node 613, 614, 615 is reduced and the performance of the wireless communication network 600 is improved.

This action relates to action 902 below.

Example embodiments of a method for managing signalling from the RAN to the CN in the wireless communication network 600 will now be described with reference to a combined flowchart and signalling diagram depicted in FIG. 7b. FIG. 7b describes the scenario where the CN node 613, 614, 615 is an S-GW 614 or P-GW 615 or a similar CN node. Thus the method takes place in the S-GW 614 or the P-GW 615 or a similar CN node and in the RAN node 612.

The method comprises the following actions, which actions may be taken in any suitable order. Dashed lines of some boxes in FIG. 7b indicate that this action is not mandatory. The description of the actions related to FIG. 7b will only define the technical features which are special to the scenario of FIG. 7b. Thus some technical features which have been described above in relation to FIG. 7a and which the skilled person understands are also applicable to the scenario of FIG. 7b will not be described below.

Action 701b.

The RAN node 612 may transmit to the S-GW 614 or the P-GW 615 the indication of congestion at the RAN node 612 also referred to as Congestion information. The indication is transmitted via the MME 613, which forwards the indication of congestion to the S-GW 614, which in turn may forward the indication to the P-GW 615.

Action 702b.

The S-GW 614 may determine overload in the CN, e.g. that the S-GW 614 or another CN node, such as the P-GW 615 is overloaded due to signalling from the RAN. Similarly, the P-GW 615 may determine that the P-GW 615 or another CN node is overloaded due to signalling from the RAN.

This action is related to action 801 below.

Action 703b.

The S-GW 614 or the P-GW 615 transmits to the RAN node 612 the indication of overload in the CN. As mentioned above, the indication of overload comprises the indication to reduce the rate of reporting congestion information to the CN.

The transmitting of the indication of overload may be triggered by an overload at the second CN node. For example, the CN node being the S-GW 614 may be triggered to transmit the indication of overload by the overload at the second CN node, being the P-GW 615.

In some embodiments the indication of overload is transmitted via a first CN node 613, 614 to the RAN node 612. For example, the S-GW 614 may transmit the indication of overload to the RAN node 612 via the MME 613. The P-GW 615 may transmit the indication of overload to the RAN node 612 via the S-GW 614 and the MME 613.

Embodiments herein comprising the interaction of more than one CN node will be described in even more detail below.

This action is related to action 802 below.

Action 704b.

When the RAN node 612 has received the indication of overload in the CN from the S-GW 614 or from the P-GW 615, via the MME 613, in action 703b, the RAN node 612 reduces the rate of reporting congestion information to the CN, based on the received indication of overload. I.e. the RAN node 612 reduces the amount of reported congestion information to the CN.

This action relates to action 902 below.

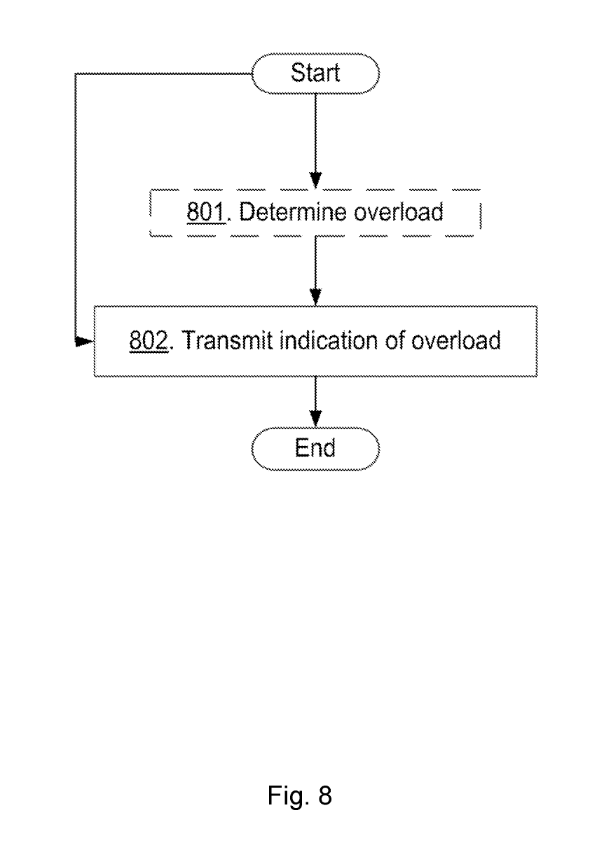

A method will now be described from a perspective of the CN node 613, 614, 615. Thus, embodiments of a method in the CN node 613, 614, 615 for managing signalling from the RAN to the CN in the wireless communication network 600 will be described with reference to a flowchart depicted in FIG. 8.

The method comprises the following actions, which actions may be taken in any suitable order. Dashed lines of some boxes in FIG. 8 indicate that this action is not mandatory.

Action 801.

The CN node 613, 614, 615 determines that the CN node 613, 614, 615 or another CN node 613, 614, 615 is overloaded due to signalling from the RAN.

The overload in the CN may be due to congestion information from the RAN.

This action relates to action 702a and 702b above.

Action 802.

The CN node 613, 614, 615 transmits to the RAN node 612 the indication of overload in the CN. The indication of overload comprises the indication to reduce a rate of reporting congestion information to the CN. Thus, when the CN node 613, 614, 615 has determined that the CN node 613, 614, 615 or another CN node 613, 614, 615 is overloaded due to signalling from the RAN the CN node 613,614,615 transmits the indication to the RAN.

In some embodiments the indication to reduce the rate of reporting congestion information to the CN comprises the indication to set the rate of reporting congestion information to the CN to a specific value.

The indication to reduce the rate of reporting congestion information to the CN may comprise the indication to increase a time-averaging period used for determining congestion information that is to be sent to the CN.

According to some embodiments the indication to reduce the rate of reporting congestion information to the CN comprises the indication to not send a part of the generated congestion information. One way of doing this is to skip sending a given percentage of the generated messages.

The transmitting of the indication of overload may be triggered by the overload at the second CN node such as the S-GW 614 and/or the P-GW 615.

In some embodiments the indication of overload is transmitted via the first CN node such as the MME 613 and/or the S-GW 614 to the RAN node 612.

The indication of overload may be transmitted in the OVERLOAD message or in the OVERLOAD START message.

This action relates to action 703a and 703b above and action 901 below.

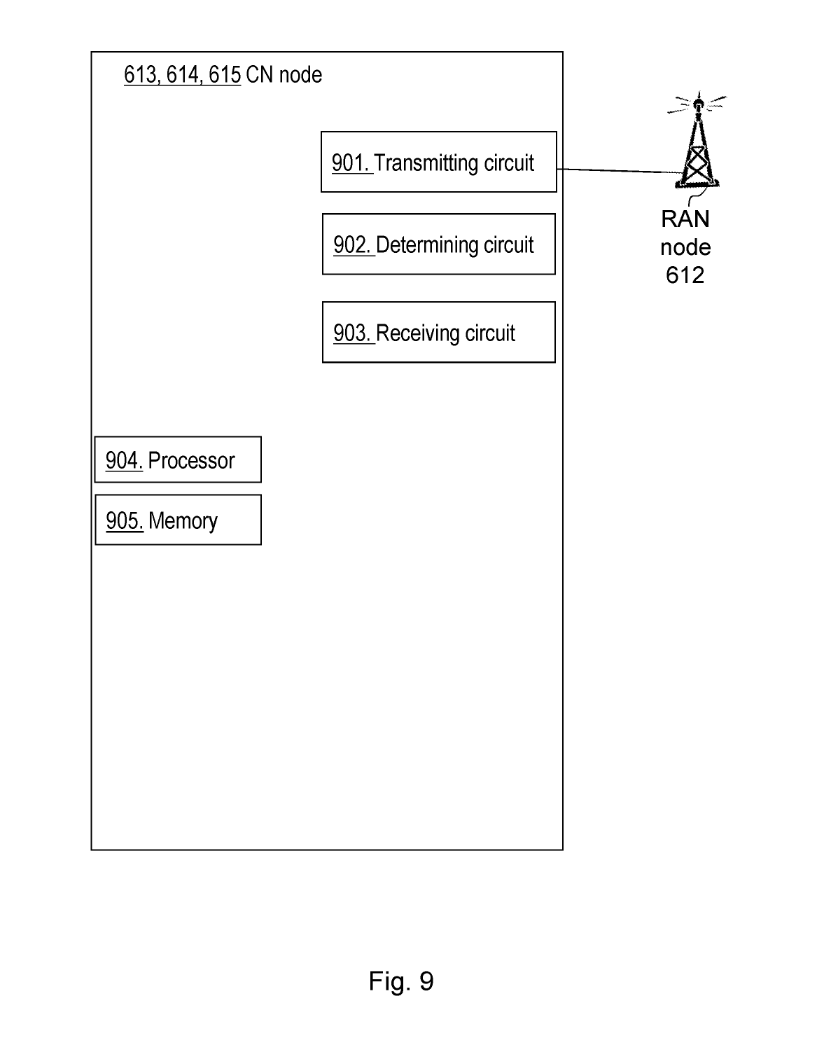

To perform the method actions for managing the signalling from the RAN to the CN in the wireless communication network 600 described above in relation to FIG. 8, the CN node 613, 614, 615 comprises the following arrangement depicted in FIG. 9.

The CN node 613, 614, 615 comprises a transmitting circuit 901. The transmitting circuit 901 is configured to transmit to the RAN node 612 the indication of overload in the CN. As mentioned above, the overload in the CN may be due to congestion information from the RAN. As mentioned above the indication of overload comprises the indication to reduce the rate of reporting congestion information to the CN. For example the indication may indicate to reduce the rate of reporting congestion information by a given amount, or to set the rate to a given value or to a pre-set value, or to stop reporting congestion information. The indication may comprise data or values indicating a reduction of rate, frequency or/and amount of indication of congestion to be signalled from the RAN node 612.

In some embodiments the indication to reduce the rate of reporting congestion information to the CN comprises the indication to increase the time-averaging period used for determining congestion information that is to be sent to the CN.

According to some embodiments the transmitting circuit 901 is configured to transmit the indication of overload triggered by the overload at the second CN node 614, 615.

The CN node 613, 614, 615 may further comprise a determining circuit 902 configured to determine that the CN node 613, 614, 615 or another CN node 613, 614, 615 is overloaded due to signalling from the RAN.

The CN node 613, 614, 615 may further comprise a receiving circuit 903 configured to receive e.g. congestion indications from one or more RAN nodes.

The embodiments herein for managing the signalling from the RAN to the CN in the wireless communication network 600, or in other words for handling signalling of congestion indications from the RAN node 612 may be implemented through one or more processors 904 in the CN node 613, 614, 615 depicted in FIG. 9, together with computer program code for performing the functions and/or method actions of the embodiments herein. The program code mentioned above may also be provided as a computer program product, for instance in the form of a data carrier carrying computer program code for performing embodiments herein when being loaded into the CN node 613, 614, 615. One such carrier may be in the form of a CD ROM disc. It is however feasible with other data carriers such as a memory stick. The computer program code may furthermore be provided as pure program code on a server and downloaded to the CN node 613, 614, 615.

The CN node 613, 614, 615 may further comprise a memory 905 that comprises one or more memory units that may be used to store data such as thresholds, overload data, applications to perform the methods herein when executed, and/or similar.

Those skilled in the art will also appreciate that the transmitting circuit 901, the determining circuit 902 and the receiver circuit 901 described above may refer to a combination of analogue and digital circuits, and/or one or more processors configured with software and/or firmware, e.g. stored in a memory, such as the memory 905, that when executed by the one or more processors, such as the processor 904, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The transmitting circuit 901, the determining circuit 902 and the receiving circuit 903 may also be respectively referred to as a transmitting module 901, a determining module 902 and a receiving module 903.

Those skilled in the art will also appreciate that the transmitting module 901, the determining module 902 and the receiving module 901 described above may refer to a combination of analogue and digital modules, and/or one or more processors configured with software and/or firmware, e.g. stored in a memory, such as the memory 905, that when executed by the one or more processors, such as the processor 904, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

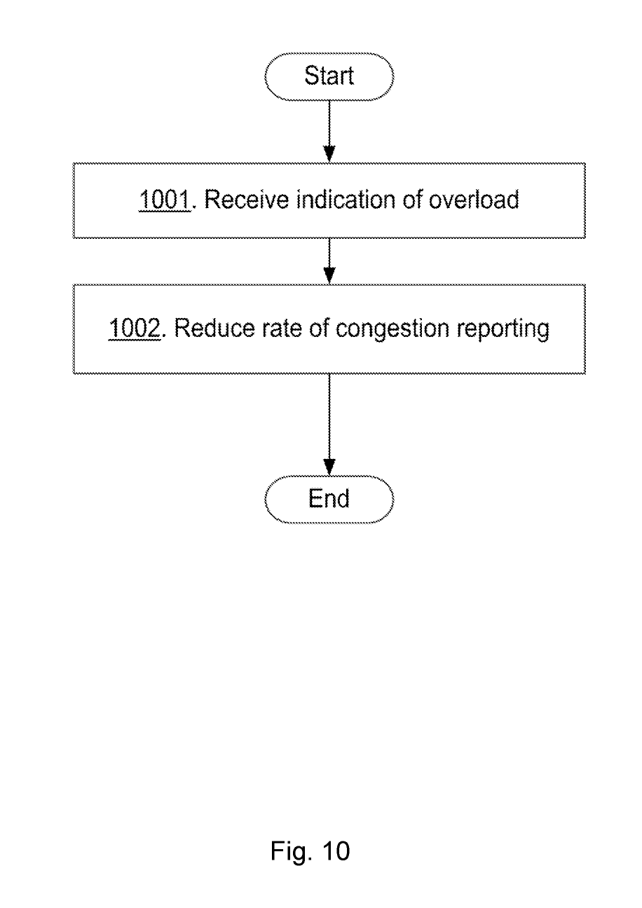

A method will now be described from a perspective of the RAN node 612. Thus, embodiments of a method in the RAN node 612 for managing the signalling from the RAN to the CN in the wireless communication network 600 will be described with reference to a flowchart depicted in FIG. 10.

The method comprises the following actions, which actions may be taken in any suitable order. Dashed lines of some boxes in FIG. 10 indicate that this action is not mandatory.

Action 1001.

The RAN node 612 receives from the CN node 613, 614, 615 the indication of overload in the CN. As mentioned above the overload is due to signalling from the RAN. The indication of overload comprises the indication to reduce the rate of reporting congestion information from the RAN to the CN. In other words, the indication of overload comprises an indication to reduce the amount of congestion indications to be sent to the CN.

The overload of signalling in the CN may be due to congestion information from the RAN.

In some embodiments the indication to reduce the rate of reporting congestion information to the CN comprises the indication to set the rate of reporting congestion information to the CN to the specific value.

The indication to reduce the rate of reporting congestion information to the CN may comprise the indication to increase the time-averaging period used for determining congestion information that is to be sent to the CN.

According to some embodiments the indication to reduce the rate of reporting congestion information to the CN comprises the indication to not report a part of the generated congestion information, for example, to skip sending a given percentage of the generated messages.

The indication of overload may be received in the OVERLOAD message or in the OVERLOAD START message.

Action 1002.

The RAN node 612 reduces the rate of reporting congestion information to the CN, based on the received indication of overload. I.e. the RAN node 612 reduces the amount of reported congestion information to the CN. For example, this may be done by gradually decreasing the rate of congestion signalling or reducing the rate of congestion signalling to a pre-set value of rate of congestion signalling.

In some embodiments the RAN node 612 reduces the rate of reporting congestion information to the CN by setting the rate of reporting congestion information to the CN to the specific value. The specific value may be determined by the indication of overload or by the pre-set value.

The RAN node 612 may reduce the rate of reporting congestion information to the CN by increasing the time-averaging period used for determining congestion information that is to be sent to the CN.

In some embodiments the RAN node 612 reduces the rate of reporting congestion information to the CN by not reporting a part of the generated congestion information.

Since the RAN node 612 reduces the rate of reporting congestion information to the CN, based on the received indication of overload, the signalling level in the CN node 613, 614, 615 is reduced.

This action relates to actions 704a and 704b above.

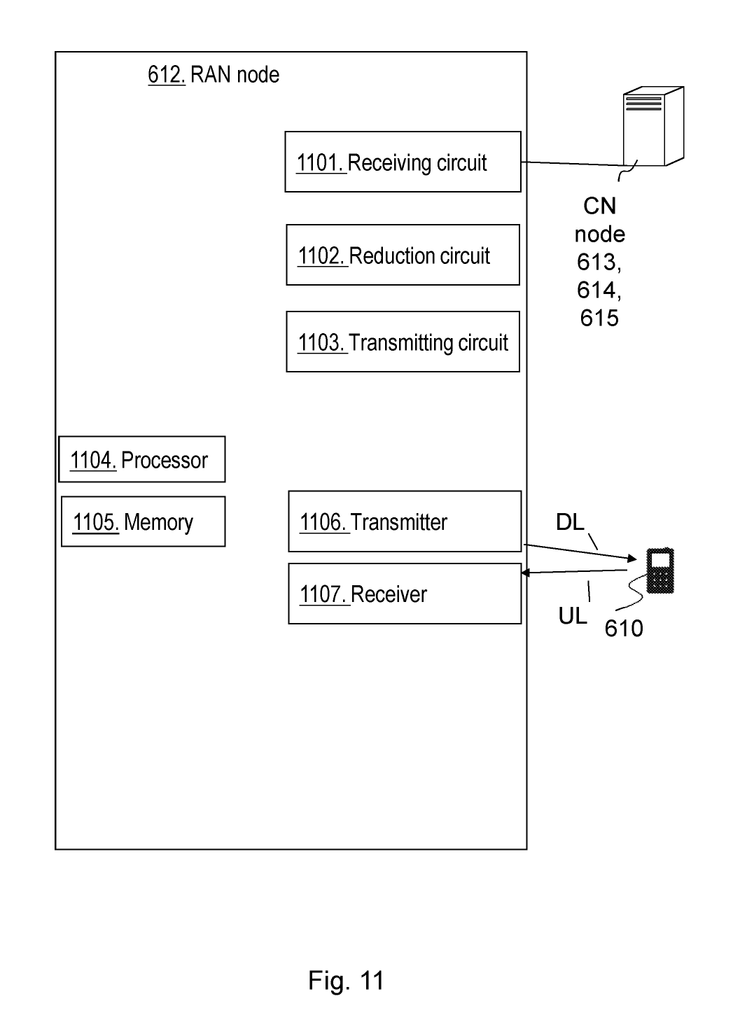

To perform the method actions for managing the signalling from the RAN to the CN in the wireless communication network 600 described above in relation to FIG. 10, the RAN node 612 comprises the following arrangement depicted in FIG. 11.

The RAN node 612 comprises a receiving circuit 1101. The receiving circuit 1101 is configured to receive from the CN node 613, 614, 615 the indication of overload in the CN, which overload is due to signalling from the RAN. The overload of signalling in the CN may for example be due to congestion information from the RAN.

As mentioned above the indication of overload comprises the indication to reduce the rate of reporting congestion information to the CN. For example the indication may indicate to reduce the rate of reporting congestion information by a given amount, or to set the rate to a given value or to a pre-set value, or to stop reporting congestion information. The indication may comprise data or values indicating a reduction of rate, frequency or/and amount of indication of congestion to be signalled from the RAN node 612.

In some embodiments the indication to reduce the rate of reporting congestion information to the CN comprises the indication to increase the time-averaging period used for determining congestion information that is to be sent to the CN.

The RAN node 612 further comprises a reduction circuit 1102 configured to reduce the rate of reporting congestion information to the CN, based on the received indication of overload.

The RAN node 612 may further comprise a transmitting circuit 1103 configured to transmit the congestion indication to the CN node 613, 614, 615 or another CN node.

The embodiments herein for managing the signalling from the RAN to the CN in the wireless communication network 600, or in other words for handling signalling of congestion indications from the RAN node 612 may be implemented through one or more processors 1104 in the RAN node 612 depicted in FIG. 11, together with computer program code for performing the functions and/or method actions of the embodiments herein. The program code mentioned above may also be provided as a computer program product, for instance in the form of a data carrier carrying computer program code for performing embodiments herein when being loaded into the RAN node 612. One such carrier may be in the form of a CD ROM disc. It is however feasible with other data carriers such as a memory stick. The computer program code may furthermore be provided as pure program code on a server and downloaded to the RAN node 612.

The RAN node 612 may further comprise a memory 1105 configured to be used to store data on, such as thresholds, rates, frequencies, congestion data, congestions indications, applications to perform the methods herein when executed and/or similar.

The RAN node 612 may further comprise a transmitter (TX) 1106 and a receiver (RX) 1107 configured to communicate with the wireless device 610.

Those skilled in the art will also appreciate that the receiving circuit 1101, the reduction circuit 1102 and the transmitting circuit 1103 described above may refer to a combination of analogue and digital circuits, and/or one or more processors configured with software and/or firmware, e.g. stored in a memory, such as the memory 1105, that when executed by the one or more processors, such as the processor 1104, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The receiving circuit 1101, the reduction circuit 1102 and the transmitting circuit 1103 may also be respectively referred to as a receiving module 1101, a reduction module 1102 and a transmitting module 1103.

Those skilled in the art will also appreciate that the receiving module 1101, the reduction module 1102 and the transmitting module 1103 described above may refer to a combination of analogue and digital modules, and/or one or more processors configured with software and/or firmware, e.g. stored in a memory, such as the memory 905, that when executed by the one or more processors, such as the processor 904, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

As will be readily understood by those familiar with communications design, that functions from other circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a network node, for example.

Alternatively, several of the functional elements of the processing circuits discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications receivers will appreciate the cost, performance, and maintenance trade-offs inherent in these design choices.

Examples of how congestion indication signalling may be reduced will now be explained with further details by means of enhancements to the E-UTRAN OVERLOAD START procedure. New values for the Overload Action Information Element (IE) will be specified. One of the new values, or more of them, may be used as a solution for reducing signalling overload.

The new values added to the Overload Action IE fulfil the following functions. A value “Reduce Congestion Indication Signalling” implies that the receiving RAN node 612 will reduce the frequency, or similar the rate, of congestion indication signalling by an amount proportional to a value of a Traffic Load Reduction Indication IE.

Alternatively, a new IE may be defined to indicate the expected amount of reduction in the congestion signalling. One means to reduce the signalling is to skip sending a given percentage of the messages, as determined by the Traffic Load Reduction Indication IE. In other words, the RAN node 612 does not send a part of the generated congestion information. Or, the RAN node 612 may change the time-averaging constant used for determining congestion information, and use longer time-averaging as a means to reduce the congestion indication signalling. The latter is an implicit means to reduce the load by the percentage as indicated in the Traffic Load Reduction Indication IE.

It may be noted that such an action is currently not possible by means of existing overload indication procedures in LTE because the only permitted actions in case of signalling overload in the CN node 613, 614, 615 are to reduce the number of UEs connected or attempting to connect to the RAN node 612. However, if the signalling overload is caused either in full or in part by the signalling of congestion indications, preventing UEs from connecting to the network would not be the most appropriate action. Therefore it is more efficient to specify dedicated values to indicate, explicitly or implicitly, a reduction in the congestion indication signalling and still allow new and existing UEs to connect to the network. For example, the CN node 613, 614, 615 may transmit data stating to reduce the congestion signalling or stating a rate, frequency or amount to use when performing congestion signalling.

Another value that may be added to the Overload Action IE is “Reset Congestion Indication Signalling Frequency”. This value indicates to the RAN node 612 that the frequency of signalling for congestion indication messages shall be reduced to a pre-set or pre-configured value. Such pre-configured value may be for example configured via the Operation Administration and Maintenance (OAM) system. Note that a possible RAN action may also be to completely stop indicating congestion level changes, just report a constant, possibly pre-configured, level of congestion. This may for example be the case in an extreme situation, such as during a network outage due to a system fault or such as during or after a disaster of some kind, e.g. an earthquake. Such an action may also be requested from the CN node 613, 614, 615 through e.g. a new Overload Action IE such as “Stop Congestion Indication”.

As another alternative, a new Overload Action IE “Set Congestion Indication Signalling Frequency” may also be used, where a new IE identifies a specific amount, such as a desired amount, of congestion indication signalling. This may be given e.g., in terms of a scalar number ranging e.g. from 0 to 10, which may be mapped to different signalling frequencies based on pre-configured settings. The signalling frequency may be altered primarily by changing the time-averaging constant used to determine the congestion information. Other parameters are also possible, e.g. the time-averaging constant may also be given explicitly. The difference from the Reduce Congestion Indication Signalling is that the specific, possibly desired, amount of signalling is indicated, rather than the relative reduction of the signalling.

In a way similar to the example described for E-UTRAN, a similar enhancement may be applied to UTRAN, by means of changes to the Priority Class Indicator IE in the OVERLOAD message. The Priority Class Indicator IE may be modified in a way that its semantics may specify that a specific bit set to 1 in a bitmap represents reduction of the signalling due to congestion indication by means of a value of the Number of Steps IE. See 3GPP TS 25.413 section 9.2.1.109 for a detailed description. In a way similar to the E-UTRAN case, a different bit in the Priority Class Indicator IE bitmap may be used to indicate that the frequency of the signalling for congestion indication shall be reduced to a pre-set value, e.g. pre-configured by the OAM system.

The overload indication may comprise any of Reduce Congestion Indication Signalling, Reset Congestion Indication Signalling Frequency, Stop Congestion Indication, Set Congestion Indication Signalling Frequency. The overload indication may further comprise Reject RRC connection establishments for non-emergency MO DT, Reject RRC connection establishments for Signalling, Permit Emergency Sessions and mobile terminated services only, Permit High Priority Sessions and mobile terminated services only, and/or Reject delay tolerant access.

As mentioned above, in some embodiments the signalling overload indication may be triggered not by the CN node 613, 614, 615 being an MME or SGSN, as specified for the OVERLOAD START procedure in E-UTRAN or in the OVERLAD procedure in UTRAN. Instead it may be started, i.e. triggered, in CN nodes that are not connected to the RAN and still subject to signalling overload due to congestion indication. Such nodes may for example be the PCRF or the P-GW or the S-GW as shown in FIG. 3.

In this case it is proposed to define new overload indications from each congested node, such as the S-GW, to the node connected to the RAN, such as the SGSN/MME. Such overload indications may be sent possibly via intermediate nodes, for example following a signalling path from the PCRF to the P-GW to the S-GW to the SGSN or the MME. The procedure is similar to the proposed enhancement for the RAN/MME/SGSN interface disclosed in embodiments herein. When receiving such overload indications the SGSN/MME may, for example, trigger procedures like the OVERLOAD START/STOP or OVERLOAD, as modified according to embodiments herein.

Alternatively, instead of using explicitly signalled overload states, i.e. a state where there is a risk that the node may not be able to perform as expected due to processing capability limitations, from the CN nodes not connected to the RAN to the MME/SGSN, it is also possible to pre-configure a certain signalling threshold into the CN node 613 connected to the RAN, such as the SGSN/MME. For example, the CN node 613 connected to the RAN may measure the amount of signalling it sends to the CN nodes not connected to the RAN. The signalling threshold may be based on the known signalling capacity of the CN nodes not connected to the RAN, such as the S-GW, P-GW and PCRF nodes. The signalling threshold may apply to the total amount of control signalling from the RAN in general, or the congestion related signalling in particular. The signalling threshold may be given e.g., as an average amount of signalling per user, or per bearer. Once the threshold is reached, the CN node 613, 614, 615 connected to the RAN, such as the SGSN/MME, may trigger the overload procedure towards the RAN to reduce the signalling.

As has been mentioned or indicated above an object of embodiments herein is to provide mechanisms to control and reduce signalling load levels of signalling congestion.

According to an aspect the object is achieved by the method in the core network node 613, 614, 615 for managing congestion reporting from the radio access network node 612 in the wireless communication network 600. The core network node 613, 614, 615 transmits to the radio access network node 612 an indication of overload at the core network node 613, 614, 615. The indication may indicate that the overload is due to signalling of congestion indications from the radio access network node 612 or other radio access network nodes. The indication of overload comprises an indication to reduce a rate of reporting congestion information to the CN.

According to another aspect the object is achieved by the method in the radio access network node 612 for handling congestion reporting from the radio access network node 612 to a core network node 613, 614, 615 in a wireless communication network. The radio access network node 612 receives from the core network node 613, 614, 615 or another core network node 613, 614, 615 an indication of overload at the core network node 613, 614, 615 or another core network node 613, 614, 615. The indication may indicate that the overload is due to signalling congestion indications from the radio access network node 612 or other radio access network nodes. The indication may comprise data or information stating to reduce signalling of congestion from the radio access network node.

According to yet another aspect the object is achieved by the core network node 613, 614, 615 configured to signal to the radio access network node 612 the indication of overload. The indication of overload may indicate that such overload is due to congestion signalling from the radio access network node or another radio access node. The indication may e.g. comprise data indicating a reduction of congestion signalling from the radio access network node.

According to yet another aspect the object is achieved by the radio access network node 612 configured to perform the method described above.

The technical problem is solved by embodiments herein by providing mechanisms to control and reduce signalling load levels by means of controlling congestion information reporting. For example, this may be achieved by transmitting in the OVERLOAD START message the indication that the overload is due to congestion signalling from RAN nodes.

Embodiments herein tackle the problem of controlling a situation of excessive signalling loads in the CN nodes, such as the CN node 613, 614, 615, where the cause of signalling is the reporting of congestion information from RAN nodes, such as the RAN node 612.

The embodiments herein enable full control of the level of signalling at which the information is reported from the RAN, hence preventing outages or performance degradation that may result in a reduction of users and traffic served.

According to embodiments herein the examples of UTRAN and E-UTRAN networks are used. However, the methods proposed are generic and may be applied to any technology, 3GPP or non-3GPP Radio Access Technologies (RAT), which shares similar signalling procedures.

The indication of the signalling overload due to congestion indication signals is sent to the RAN node 612 by the CN node 613, 614, 615 such as the MME and the SGSN. The CN node 613, 614, 615 may reuse existing procedures to inform the RAN node 612 that a reduction of signalling due to congestion indication needs to be enforced. Alternatively, a new procedure from the CN node 613, 614, 615 to the RAN node 612 is also possible for this purpose.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method in a Core Network, CN, node for managing signalling from a Radio Access Network, RAN, to a CN in a wireless communication network, the method comprising:
transmitting to a RAN node an indication of overload in the CN, which overload is due to signalling from the RAN, and which indication of overload comprises an indication to reduce a rate of reporting congestion information to the CN.

2. The method according to claim 1, further comprising determining that the CN node or another CN node is overloaded due to signalling from the RAN.

3. The method according to claim 1, wherein the indication to reduce the rate of reporting congestion information to the CN comprises an indication to set the rate of reporting congestion information to the CN to a specific value.

4. The method according to claim 1, wherein the indication to reduce the rate of reporting congestion information to the CN comprises an indication to increase a time-averaging period used for determining congestion information that is to be sent to the CN.

5. The method according to claim 1, wherein the indication to reduce the rate of reporting congestion information to the CN comprises an indication to not send a part of the generated congestion information.

6. The method according to claim 1, wherein the overload in the CN is due to congestion information from the RAN.

7. The method according to claim 1, wherein the transmitting of the indication of overload is triggered by an overload at a second CN node.

8. The method according to claim 1, wherein the indication of overload is transmitted via a first CN node to the RAN node.

9. The method according to claim 1, wherein the indication of overload is transmitted in an OVERLOAD message or in an OVERLOAD START message.

10. A Core Network, CN, node for managing signalling from a Radio Access Network, RAN, to a CN in a wireless communication network, the CN node comprising:
a transmitting circuit configured to transmit to a RAN node an indication of overload in the CN, which overload is due to signalling from the RAN, and which indication of overload comprises an indication to reduce a rate of reporting congestion information to the CN.

11. The CN node according to claim 10, further comprising a determining circuit configured to determine that the CN node or another CN node is overloaded due to signalling from the RAN.

12. The CN node according to claim 10, wherein the indication to reduce the rate of reporting congestion information to the CN comprises an indication to increase a time-averaging period used for determining congestion information that is to be sent to the CN.

13. The CN node according to claim 10, wherein the overload in the CN is due to congestion information from the RAN.

14. The CN node according to claim 10, wherein the transmitting circuit is configured to transmit the indication of overload triggered by an overload at a second CN node.

15. A method in a Radio Access Network, RAN, node for managing signalling from a RAN to a Core Network, CN, in a wireless communications network, the method comprising:
receiving from a CN node an indication of overload in the CN, which overload is due to signalling from the RAN and which indication of overload comprises an indication to reduce a rate of reporting congestion information from the RAN to the CN, and
reducing the rate of reporting congestion information to the CN, based on the received indication of overload.

16. The method according to claim 15, wherein the indication to reduce the rate of reporting congestion information to the CN comprises an indication to set the rate of reporting congestion information to the CN to a specific value.

17. The method according to claim 15, wherein the indication to reduce the rate of reporting congestion information to the CN comprises an indication to increase a time-averaging period used for determining congestion information that is to be sent to the CN.

18. The method according to claim 15, wherein the indication to reduce the rate of reporting congestion information to the CN comprises an indication to not report a part of the generated congestion information.

19. The method according to claim 15, wherein the overload of signalling in the CN is due to congestion information from the RAN.

20. The method according to claim 15, wherein the indication of overload is received in an OVERLOAD message or in an OVERLOAD START message.

21. A Radio Access Network, RAN, node for managing signalling from a RAN to a Core Network, CN, in a wireless communications network, the RAN node comprising:
a receiving circuit configured to receive from a CN node an indication of overload in the CN, which overload is due to signalling from the RAN, and which indication of overload comprises an indication to reduce a rate of reporting congestion information from the RAN to the CN, and
a reduction circuit configured to reduce the rate of reporting congestion information to the CN, based on the received indication of overload.

22. The RAN node according to claim 21, wherein the indication to reduce the rate of reporting congestion information to the CN comprises an indication to increase a time-averaging period used for determining congestion information that is to be sent to the CN.

23. The method according to claim 21, wherein the overload of signalling in the CN is due to congestion information from the RAN.
